(19) United States
(12) Patent Application Publication
(10) Pub. No.: US 2006/0077865 A1
(43) Pub. Date: Apr. 13, 2006

(54) Tight focusing method and system

(75) Inventors: Ori Eytan, Haifa (IL); Curt Shuman, Colorado Springs, CO (US); Thierry Wasserman, Tel Aviv (IL); Charles Ernst, Colorado Springs, CO (US)

Correspondence Address: BROWDY AND NEIMARK, P.L.L.C.;624 NINTH STREET, NW, SUITE 300, WASHINGTON, DC, 20001-5303, US

(73) Assignee: Mempile Inc., Wilmington, DE (US)

(21) Appl. No.: 10/530,402

(22) PCT Filed: Oct. 7, 2003
(86) PCT No.: PCT/IL03/00803

§ 371 Date: Oct. 28, 2005

Related U.S. Application Data
(60) Provisional application No. 60/416,274, filed on Oct. 7, 2002.

(51) Int. Cl. G11B 7/00

(52) U.S. Cl. 369/125

(57) ABSTRACT

A method and system are presented for use in recording/reading data from an array of data units within a three-dimensional storage medium. Exciting radiation is provided in the form of first and second light beams of first and second different wavelengths, respectively. The first and second light beams are concurrently directed and focusing onto desirably distanced from each other sites in the medium and excited light of a third wavelength coming from the excited site is collected to form and excited light beam to be directed towards a detector assembly, while correcting for chromatic and spherical aberrations of the light focusing and collection. This focusing/collection is sequentially repeated for successive sites in the medium with varying depth of focus

### FIELD OF THE INVENTION

This invention is generally in the field auto-focusing techniques, and relates to a method and device for tight focusing a beam of electromagnetic radiation while recording/reading information in a three-dimensional storage medium.

### BACKGROUND OF THE INVENTION

Three-dimensional optical memory devices have been developed being aimed at significantly increasing the amount of recordable data, as compared to the conventional two-dimensional devices (typically two data-layer containing structures).

U.S. Pat. No. 5,268,862 discloses a three-dimensional optical memory, in which an active medium, typically a photochromic material and more typically spirbenzopyran, is maintained in a three-dimensional matrix, typically of polymer, and is illuminated in selected regions by two light beams, of 532 nm and 1064 nm wavelength, to change from a first, spiropyran, to a second, merocyanine, stable molecular isomeric form by process of two-photon absorption. Regions not temporally and spatially coincidently illuminated are unchanged. Later illumination of the selected regions by two light beams, of 1064 nm wavelength each, causes only the second, merocyanine, isomeric form to fluoresce. This fluorescence is detectable by photodetectors as stored binary data. The three-dimensional memory may be erased by heat, or by infrared radiation, of 2.12 microns wavelength. Use of other medium permit the three-dimensional patterning of three-dimensional forms, such as polystyrene polymer solids patterned from liquid styrene monomer. Three-dimensional displays, or other inhomogeneity patterns, can also be created.

U.S. Pat. No. 6,071,671 discloses a method of manufacturing a fluorescent 3-D optical memory device implementing an active medium capable of storing information at high information density, and an optical memory device manufactured by this method. The active medium employed in the present invention is a material capable of existing in at least 2 isomeric forms. Transition from one form to another can be induced upon illuminating this material by a “writing” electromagnetic radiation having a first spectrum. At the same time the other isomeric form is capable of fluorescence upon illuminating this material by a “reading” electromagnetic radiation with a second spectrum. By virtue of illuminating with a radiation having the first spectrum there are created elemental cells within a medium material, containing substantially the same isomeric form thereof, which can be either that form which is capable of fluorescence or the other one which is not. The information is stored within the medium as numerical values associated with the amount of one of the isomeric forms of active medium contained within elemental cells distributed within the active medium.

WO 01/73779, assigned to the assignee of the present application, discloses a three-dimensional memory apparatus for storing information in a volume comprising of an active medium. The active medium is capable of changing from a first to a second isomeric form as a response to radiation of a light beam having energy substantially equal to first threshold energy. The concentration ratio between a first and a second isomeric form in any given volume portion represents a data unit. The active medium in the memory apparatus includes diarylalkene derivatives, triene derivatives, polyene derivatives or a mixture thereof. Reading the data units from the isomeric states of the active medium is based on the fact that the two isomeric forms have substantially different absorption coefficients for absorbing energy of second threshold energy. Reading may also be carried out by measuring the scattering pattern of the two isomeric forms.

Optical storage devices have customarily been dependent on the ability to focus a laser beam to a tight spot of the order of its diffraction limit so as to allow for squeezing of as much information as possible onto the surface of the storage device. This requires correction for optical aberrations.

U.S. Pat. No. 5,841,753 discloses an optical information storage system having a multi-recording-layer record carrier and a scanner device for the carrier. The scanner produces a radiation beam which is compensated for spherical aberration for a single height of the scanning spot with the stack of layers. The height of the stack is determined by the maximum spherical aberration permissible for the system. The number of layers in the stack is determined by the minimum distance between layers, which depends on the crosstalk in the error signals due to currently unscanned layers.

U.S. Pat. No. 6,064,529 describes a method of spherical aberration correction using flying lens in an optical access device for a moving optical data storage media. This technique utilizes a single incident light beam and detection of reflections of this beam from the media. The flying lens is located near an outer surface of the media, and an objective lens is spaced from the flying lens. The flying lens and objective lens co-operate to substantially offset a variable range of negative spherical aberration occurring in the media by forming a positive spherical aberration which substantially cancels the negative spherical aberration.

U.S. Pat. No. 6,091,549 discloses a method and apparatus for adjustable spherical aberration correction and focusing. According to this technique, two lenses separated by an air gap are used to provide spherical aberration compensation and focusing of a light beam to a focal point inside a data storage medium. The thickness of the air gap determines the amount of spherical aberration compensation provided. The distance between the lens pair and storage medium determines the depth of the focal point within the storage medium. The internal surfaces of the lenses which define the air gap are preferably planar. The external surfaces of the lenses are aspheric to provide accurate focusing and positive spherical aberration. The air gap between the lenses may also be formed by curved internal surfaces, in which case it is best for the focus lens to have a concave internal surface. The apparatus and method of the present invention reduces the number of optical components required for an optical data reading/writing device.

U.S. Pat. No. 6,310,840 discloses an optical scanning device for use in an optical player. The scanning device includes an optical lens system for focusing a light beam into a scanning spot on a track of an information carrier. The scanning device includes a first actuator for displacing the lens system parallel to an optical axis for focusing the light beam on the information carrier. The lens system includes a main lens or objective lens and an auxiliary or solid immersion lens, providing the lens system with a large numerical aperture, so that the scanning device is suitable for scanning information carriers with a high information density, such as, for example, high-density compact discs. The auxiliary lens is secured in a fixed position to the housing of the lens system, while the main lens is suspended in the housing in a direction parallel to the optical axis by an elastically deformable mounting unit The lens system includes a second actuator for moving the main lens relative to the auxiliary lens in a direction parallel to the optical axis for compensating for spherical aberration in a transparent protection layer of the information carrier. Thus, the necessary power of the first actuator is limited considerably.

### SUMMARY OF THE INVENTION

There is a need in the art to facilitate reading and recording information processes while correcting for chromatic and spherical aberrations in a data storage medium of the kind where a radiation response of the medium is excitable by exciting reading and recording beams of different wavelengths and the excited response is of a wavelength different from that of the reading and recording beams. The data recording process is typically concurrent with the reading process from the same sites in the medium. In the medium of this kind, the reading and recording beams of different wavelengths are thus to be simultaneously focused to and the response of a third different wavelength is to be collected from the same site.

It should be understood that the term “recording” used herein signifies one of the data writing and erasing processes.

The present invention provides for focusing two exciting beams of electromagnetic radiation of different wavelengths (e.g., laser beam) onto the same site in a three-dimensional medium at various depths while keeping the desired beam spatial characteristics, thereby enabling reading and recording data in the medium. The main idea of the present invention consists of compensating for the chromatic and spherical aberrations over the whole range of focal depths that are of interest to a particular implementation.

As indicated above, in order to enable focusing a laser beam to a tight spot of the order of its diffraction limit and thereby allow for squeezing as much information as possible onto the surface of the storage device, all optical aberrations are to be corrected. The spherical aberration of a particular optical setup is dependent on the nature of the material the light traverses and the length of the path through it. When dealing with simultaneous focusing of two light beams of different wavelengths via the same focusing/collecting arrangement, a problem with chromatic aberrations of focusing arises.

The present invention takes an advantage of the facts that optical storage devices have customarily stored data within a particular and known depth of transparent material, and the material can be excited to respond to specific known wavelengths of exciting radiation, and provides for a method and optical system that corrects for chromatic and spherical aberrations appropriate to the particular depth standard for a particular data storage medium.

While reading/recording data in a three-dimensional storage medium (e.g., a monolithic translucent material), incident light beams of different wavelengths after passing through a lens arrangement traverse two distinct materials (e.g., air followed by a clear plastic) and is focused within the second material (storage medium). The present invention solves the problem of correction of chromatic and spherical aberrations by tailoring the focusing/collecting arrangement to enable focusing of two exciting light beams of different wavelengths onto desirably distanced from each other sites in the medium and detecting excited light coming from the medium while correcting for chromatic and spherical aberrations of focusing/collection. This is implemented by appropriately designing the focusing/collecting arrangement (i.e., a number of lenses, their relative accommodation and geometry) to adjust a degree of divergence/convergence of the exciting light beams' when arriving to the focusing/collecting arrangement, as well as the collection of the excited light, and the light propagation in between the focusing/collecting arrangement and the medium. It should be noted that with regard to excited light, the focusing/collection assembly receives a portion of this light impinging onto the focusing/collecting arrangement and forms an excited light beam to propagate towards a detector assembly. Thus, the term “excited light beam” or “excited beam” used herein signifies either one of excited radiation or shaped excited beam, depending on the excited light propagation location, namely, respectively, between the focusing/collecting arrangement and the medium, and between the focusing/collecting arrangement and the detector assembly.

Thus, according to one broad aspect of the present invention, there is provided a method for use in recording/reading data from an array of data units within a three-dimensional storage medium, the method comprising:
(i) providing exciting radiation in the form of first and second light beams of first and second different wavelengths, respectively;
(ii) concurrently directing said first and second light beams and focusing them onto desirably distanced from each other sites in the medium and collecting excited light of a third wavelength coming from the medium to form a third excited light beam and direct it towards a detector assembly, while correcting for chromatic and spherical aberrations of the light focusing and collection;
(iii) sequentially repeating step (ii) for successive sites in the medium with varying depth of focus.

The focusing and collecting include passing the exciting light beams and the excited light through the same focusing/collecting arrangement. The geometry of the focusing/collecting arrangement and its accommodation relative to the medium and to light source and detector assemblies are optimized to be capable of focusing each of the exciting light beams to said desirably distanced from each other sites in the medium and detecting the beam of the collected excited light coming from the excited site in the medium.

The focusing/collecting arrangement comprises two lens assemblies accommodated in an optical path of the exciting and excited light beams and being arranged in a spaced-apart relationship along an optical axis of the focusing/collecting arrangement. One of these two lens assemblies is designed to perform the majority of light bending required for the focusing of the exciting light and collecting the excited light, and the other lens assembly is designed to compensate for changing spherical aberration introduced by a change in a thickness of the medium into which the exciting light is being focused. The lenses of the focusing/collecting arrangement have different surface geometries, at least one of these surfaces being aspheric.

Preferably, that one of the two lens assemblies which is designed to compensate for changing spherical aberration is located closer to the medium. This lens may be a flying lens.

That one of the two lens assemblies which is designed to perform the majority of light bending may be configured to define two lens portions of different materials and geometries. In this case, the lens portions may be separate lens elements arranged in a spaced-apart relationship along the optical axis either with a gap between them or being attached to each other.

Alternatively, that one of the two lens assemblies which is designed to perform the majority of light bending may be located closer to the medium. In this case, the other one of the two lens assemblies may be a multiple-lens assembly, for example including three spaced-apart different lenses.

The variation of the depth of focus is preferably implemented by displacing at least one of the lenses of the focusing/collecting arrangement with respect to at least one other lens thereof along the optical axis, and more preferably displacing only that one of the lens assemblies which is designed to perform the majority of light bending. Generally, however, the entire focusing/collecting arrangement, as well the light source and detector assembly can be movable with respect to each other and/or with respect to the medium.

The correction of chromatic aberrations of focusing/collection may be carried out during the exciting beams' propagation towards the focusing/collecting arrangement and the excited beam propagation from the focusing/collecting arrangement, by pre-shaping the exciting beams and post-shaping of the collected excited beam, while correction of spherical aberration is carried out by the focusing/collecting arrangement. The pre-shaping consists in providing a desired degree of the beam divergence or convergence when arriving at the focusing/collecting arrangement Several examples of pre-shaping are possible: The pre-shaping may consist in providing a slight divergence or convergence of each of the exciting beams, thereby providing semi-infinite conjugation of the exciting beams. The pre-shaping may consist in providing a larger degree of divergence or convergence of each of the exciting beams, so as to provide finite conjugation of the exciting light beams. The pre-shaping may consist in collimating one of the first and second exciting light beams and providing a slight divergence/convergence of the other exciting beam when arriving to the focusing/collecting arrangement so as to provide the semi-infinite conjugation of said other beam. The pre-shaping may include collimation of each of said first and second exciting light beams. The post-shaping of the excited light beam consists of providing a desired divergence or convergence of the excited beam when arriving at the detector assembly.

The first and second exciting beams may be, respectively, reading and recording light beams, or both be reading or recording light beams.

According to another broad aspect of the invention, there is provided an optical system for use in recording/reading data from an array of data units within a three-dimensional storage medium, the system comprising:
(a) a light source assembly operable to produce exciting radiation in the form of first and second light beams of first and second different wavelengths, respectively, thereby enabling excitation of desirably distant from each other sites in the medium to produce excited light of a third wavelength;
(b) a detector assembly for receiving the excited light and generating data indicative thereof;
(c) a focusing/collecting assembly accommodated in the optical path of propagation of said exciting and excited light, a geometry of said focusing/collecting arrangement and its accommodation relative to the medium and to the light source and detector assemblies being optimized to enable directing the exciting light beams and focusing them onto said desirably distant from each other sites and enable collecting of the excited light to form an ex cited light beam to be directed to the detector assembly, while correcting for chromatic and spherical aberrations of focusing; and
(d) a drive means associated at least with the focusing/collecting arrangement to move at least one of lenses of the focusing/collecting arrangement along an optical axis of the focusing/collecting arrangement to thereby effect variation of a depth of focus, while the exciting radiation is applied to successive sites in the medium during a relative displacement between the system and the medium.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic illustration of a reading/recording system according to one embodiment of the invention;

FIGS. 2A to 2C exemplify the operation of the system of FIG. 1;

FIGS. 3A and 3B exemplify three examples, respectively, a tight focusing/collecting arrangement according to another embodiment of the present invention suitable for use in a reading/recording system;

FIG. 4 schematically illustrates a reading/recording system according to yet another embodiment of the invention.

### DETAILED DESCRIPTION OF THE INVENTION

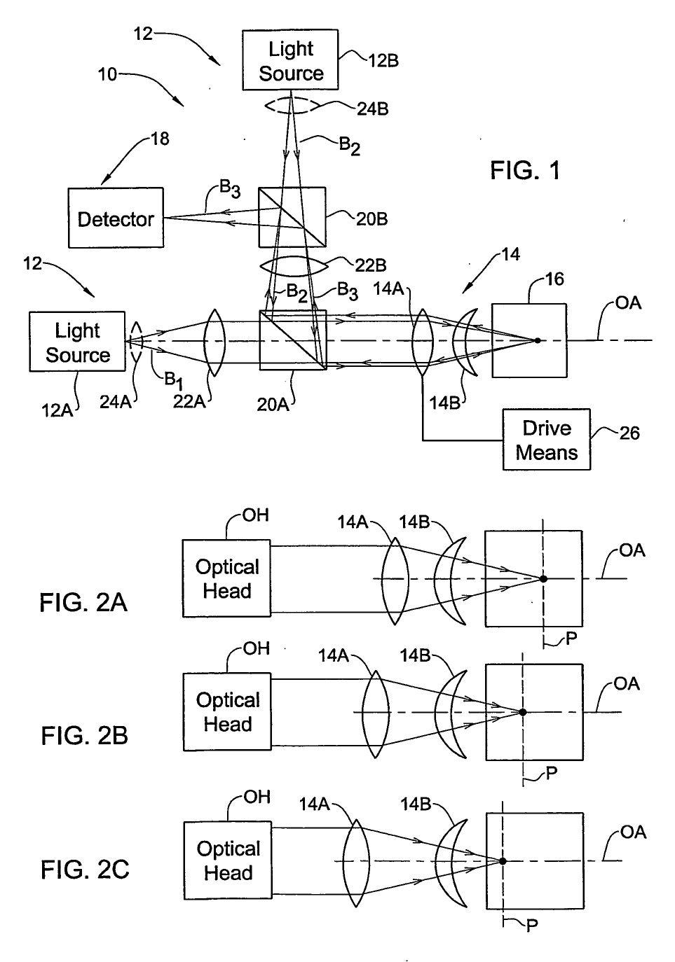

Referring to FIG. 1, there is illustrated an optical system 10 of the present invention designed for reading/recording information in a data storage medium (disk) 16. As indicated above, the term “recording” signifies either one of data writing and erasing processes.

The system 10 includes such main constructional parts as a light source assembly 12, a detector assembly 18, and a tight focusing/collecting arrangement 14. The present invention utilizes simultaneous excitation of desirably distanced from each other sites in the medium (e.g., zero distance, namely the same site), by two exciting light beams of first and second different wavelengths, respectively, and detection of an excited light beam of a third wavelength coming from the excited site. To this end, the light source assembly 12 generates first and second exciting beams B₁ and B₂, which in the present example is implemented by using separate light sources 12A and 12B, respectively. It should be understood that these two beams may be both “reading” or both “recording” beams, considering the so-called “two-photon excitation” for each of the reading and recording processes, or may be respectively “reading” and “recording” beams considering the data recording process accompanied by the reading process. It should also be noted, although not specifically shown, that the light source assembly may comprise an additional light source generating radiation serving for erasing the previously recorded data. In this case, the data erasing process would be accompanied by data reading, and thus the two concurrent exciting beams would create “erasing” and “reading” spots. The detector assembly 18 includes a photodetector that may be equipped with wavelength-selective filters and suitable optics (including focusing optics).

The construction of the disk 16 does not form part of the present invention, except to note that it is of either one of ROM (Read Only Memory), WORM (Write Once Read Many), and recordable (rewritable) memory types. More specifically, the present invention is used with a data storage medium in the form of a monolithic translucent substrate. The monolithic nature of the storage material entails a uniformity of the optical parameters of the disk resulting in a homogeneous index of refraction and absorption coefficient throughout the disk This allows for designing the focusing device with an aberration corrector of a known range of motion and overall behavior. The disk may for example be designed as described in WO 01/73779 and WO 03070689, both assigned to the assignee of the present application. According to this technique, the substrate medium (active medium, e.g., including diarylalkene derivatives, triene derivatives, polyene derivatives or a mixture thereof) is of the type capable of changing from a first isometric form to a second isomeric form in response to a light beam having energy substantially equal to first threshold energy. The concentration ratio between the first and second isomeric forms in any given volume portion represents a data unit. The active medium may be embedded in a supporting matrix, which may be a polymer, and the active medium is chemically bound thereto. Alternatively the supporting matrix may be a wax or a micelle and the active medium is homogeneously distributed therein. The information is stored as a series of data units. Data reading is based on reading data units from the isomeric states of the active medium in different portions of the active medium, where the two isomeric forms have a substantially different absorption coefficient for absorbing energy of second threshold energy. Reading may also be carried out by measuring the scattering pattern of the two isomeric forms. The disk 16 may be provided with a specific coating, for example for the purposes of protecting it against UV radiation. The disk 16 may for example be protected within a cartridge.

In the monolithic active medium 16, a data layer is considered as one data set inscribed at a specific depth (within a specified tolerance). Layers with very tight depth tolerance can be considered as having fixed depth. Layers with loose depth tolerances will be termed as layers with variable depth. Data is recorded (written/erased) in a specified layer by changing the state of the substrate within a localized volume element, defined by the focus of the read/write/erase optical beams. The present invention provides for dynamic focusing of light beams of different wavelengths in a large number of layers with fixed depths, and in a large number of layers of variable depth.

Thus, light source (e.g., laser diode) 12A is operable to generate a “recording” (e.g., writing) beam of light B₁ of a suitable wavelength range (e.g., visible or UV spectrum, e.g., 660 nm) to create data units in the disk, e.g., effect local changes in the medium from the first isometric form to the second isomeric form. Light source 12B is operable to generate a “reading” beam of light B₂ of a suitable wavelength range (e.g., in the IR spectrum, e.g., 780 nm) to affect a radiation response of the medium to the incident radiation B₂. As indicated above, exciting beams B₁ and B₂ to be simultaneously focused may be both reading or both recording beams.

The operation of the light source and detector assemblies enables carrying out in parallel emission of the reading and writing optical beams and the detection of optical response from the disk without any mutual interference between these light signals. As noted above, the light source assembly may also include a light source for producing an “erasing” light spot. Each of the light sources may include more than one laser diode and may generate light beams of different wavelength ranges. It should also be noted that reading of information stored in the disk may be implemented by exciting and measuring the Raman scattering from the disk.

The system 10 also includes light directing arrangement for concurrently directing first and second exciting beams to the focusing/collecting arrangement and directing to the detector a light beam B₃ formed from the emanating excited light (e.g., 500-550 nm) collected by the focusing/collecting arrangement. This light directing assembly includes beam splitters 20A and 20B, which are preferably wavelength-selective. Beam splitter 20A transmits the wavelength range of the first exciting beam B₁ and reflects those of the second exciting and excited beams B₂ and B₃, and beam splitter 20B transmits the wavelength range of second exciting beam B₂ and reflects that of the excited beam B₃, thus spatially separating between illuminating (exciting) radiation and radiation (excited) returned from the disk.

For the purposes of correcting chromatic aberrations of light focusing and collection for light beams of different wavelengths, the system 10 also comprises an exciting beam shaping means located upstream of the focusing/collecting arrangement with respect to the direction of propagation of the excited radiation (the so-called “pre-shaping” means), and an excited beam shaping means located between the focusing/collecting arrangement and the detector assembly (the so-called “post-shaping” means). The main function of the “pre-shaping” means consists of providing the exciting beams arrival at the focusing/collecting arrangement with predetermined degree of the beams divergence or convergence, so as to enable concurrent focusing of the two beams of different wavelengths, with the same focusing/collecting arrangement, onto desirably distanced from each other spots (sites) in the medium, which may for example be the same site (i.e., zero distance). The main function of the “post-shaping” means consists of providing a desired degree of divergence or convergence of the exciting beam when reaching the detector assembly to thereby enabling focusing of this beam onto a light detecting surface. The pre-shaping and post-shaping means are constituted by a lens assembly, which in the present example includes two lenses 22A and 22B accommodated in the optical paths of light beams B₁ and B₂ propagating towards the focusing/collecting arrangement 14. The lens 22B is also accommodated in the optical path of the collected excited beam and thus serves as the post-shaping means. Possible examples of the system configuration and beams propagation will be described more specifically further below.

The tight focusing/collecting arrangement 14 is constructed and operated to enable the correction of spherical aberrations and the tight focusing of the beams of different wavelengths into the disk with a desired distance between excited spots, and the efficient collection of the excited light of a third different wavelength range from the excited site. The inventors have found that correcting spherical aberrations over a predefined thickness of a specific material for specific wavelengths may be achieved by using only two separate optical assemblies—a first, main lens assembly 14A (which in the present example of FIG. 1 is composed of a single lens portion of a specific geometry and material) that performs the majority of the light bending required for the focusing of light, and a second auxiliary lens assembly (corrector) 14B that mainly compensates for the changing spherical aberration introduced by the changing of the thickness into which the light is being focused. Generally, aberration types that can be corrected are those induced by light traversing through varying depth within the disk material and include for example spherical aberrations and comas.

The lens assemblies 14A and 14B are arranged in a spaced-apart relationship along an optical axis OA defined by these lens assemblies, with the corrector lens 14B being accommodated downstream of the main lens 14A, i.e., closer to the medium 16. The lenses 14A and 14B are appropriately designed to correct for spherical aberrations, while scanning various depths in the medium by two beams of different wavelengths. At least one of the lenses' surfaces is typically aspheric, with no need for complementary shapes of the lens' surfaces. At least one of these lenses 14A and 14B is movable along the optical axis. Preferably, the corrector lens 14B is kept at a certain constant distance from the disk, and the main lens 14A is movable. In the present example of FIG. 1, the system comprises a drive means 26 associated only with the main lens assembly 14A for moving it along the optical axis, while all the other elements of the system (light sources, detector and corrector) are mounted stationary. The stabilization of corrector lens 14B at a fixed distance from the disk can be achieved either by using a mechanical actuator (not shown) or by appropriately configuring a holder of the lens 14B to enable the lens' stabilization by air flow caused by the disk rotation, the so called ” flying lens“(Satoshi Shimokawa, et al., “Optical Flying Head System that Featuring Dual-Stage Tracking for Use in High-Density Magneto-Optical Recording”, Jpn. J. Applied Phys., Vol. 42, 2003, pp. 873-874).

Thus, in the preferred embodiment of the implementation of system 10, only the lens 14A is mounted for movement, while the other elements—corrector 14B, light sources and detector—are stabilized. This provides for the simplicity and applicability of the design, as far as mechanics and feedback mechanisms are concerned. Generally, however, at least one of the other elements may be movable as well, namely, as far as degrees of freedom are concerned, one or more optical elements of the system can be moved. Preferably, the corrector 14B is stabilized at a fixed distance from the disk, either by mechanical actuation or by a flying lens mechanism, and movement only of the main lens is used.

Possible examples of the system configuration and beams' propagation scheme are as follows:

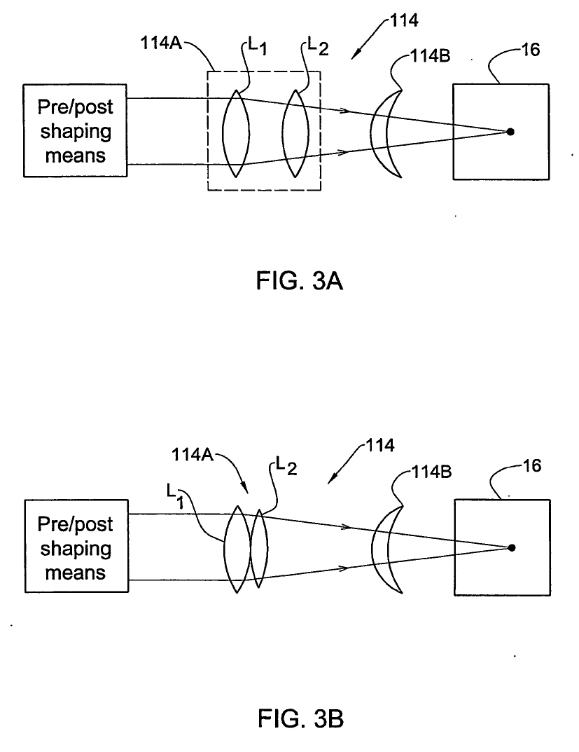

(1) Two exciting beams B₁ and B₂ are both pre-shaped to be collimated (infinite conjugation). In this case, collimating lenses 22A and 22B are provided—lens 22A in the optical path of light generated by light source 12A, and lens 22B in the optical path of light generated by light source 12B. The same lens 22B serves for post-shaping of the collected excited beam. In this case, the focusing and the correction for spherical and chromatic aberrations are all achieved using lenses 14A is and 14B, where the main lens 14A is preferably a “doublet” lens assembly, as will be described further below with reference to FIGS. 3A-3B. Parameters of the lenses of the focusing/collecting arrangement in this case are exemplified in Tables 3A and 3B.

(2) Two exciting beams B₁ and B₂ are pre-shaped such that the beams both arrive at the focusing/collecting arrangement as non-collimated (with slight divergence/convergence—the so-called “semi-infinite” conjugation, or with divergence/convergence at a larger degree—“finite” conjugation). It should be understood that, generally, the predetermined degree of the exciting beam divergence/convergence when arriving at the focusing/collecting arrangement can be achieved by appropriately adjusting a distance between the respective light source and the focusing/collecting arrangement. In this case, the pre-shaping is achieved with no specific optical element. Preferably, however, a lens assembly (lenses 22A and 22B) is used for this purpose. The lenses 22A and 22B are appropriately designed and oriented with respect to the light sources 12A and 12B to provide the desired degree of divergence/convergence of the beams propagation, while arriving at the focusing/collecting arrangement. It should be noted, although not specifically shown, that the same may be achieved by using collimating lenses 22A and 22B and additional lenses in the optical paths of collimated beams B₁ and B₂ to further affect these beams to provide the desired degree of non-collimation of these beams when arriving at the focusing/collecting arrangement. It is important to note that in order to achieve tight focusing and collection of different wavelengths through a specific optical path that for itself is not corrected for chromatic aberrations, the incoming beams must approach different divergence or convergence, and the focusing/collection optics must accommodate for the beam divergence/convergence or focus angle of the beam emerging from the focusing and spherical aberration correction optics. An example of the parameters of the lenses in the case of two diverging/converging beams (two finite conjugations) is given in the following Table 1 (where the surfaces are counted from the laser source to the disk).

TABLE 1

| Surface | | | | | |
|---|---|---|---|---|---|
| description | Curvature | Thickness | Glass | Semi-Diameter | Conic |
| First surface, | 1.5251E−02 | 1.9116E+00 | PBH71 | 3.2146E+00 | 3.7301E+02 |
| main lens | | | | | |
| Second | −1.7270E−01 | | | 3.3962E+00 | −4.8148E+00 |
| surface, main | | | | | |
| lens | | | | | |
| First surface, | −7.1443E+303 | 1.1460E+00 | PBH71 | 2.3583E+00 | −1.7341E+07 |
| aux lens | | | | | |
| Second | 3.8962E+304 | | | 1.8738E+00 | −5.5793E+38 |
| surface, aux | | | | | |
| lens | | | | | |

Aspheric, higher order coefficients:

| Surface | | | | |
|---|---|---|---|---|
| description | 2nd order | 4th order | 6th order | 8th order |
| First surface, | 5.9857E−02 | −2.4349E−03 | 7.3797E−07 | −3.8949E−05 |
| main lens | | | | |
| Second surface, | 1.7276E−02 | −3.2527E−04 | −3.4591E−04 | −3.2331E−07 |
| main lens | | | | |
| First surface, aux | 4.2350E−02 | 1.0412E−02 | −1.4509E−03 | 1.0142E−04 |
| lens | | | | |
| second surface, | 2.6084E−03 | 1.9457E−02 | −5.3978E−03 | 1.1652E−04 |
| aux lens | | | | |
| Surface | | | | |
| description | 10th order | 12th order | 14th order | 16th order |
| First surface, | −5.0609E−07 | 4.0824E−07 | −6.9934E−09 | −1.3555E−09 |
| main lens | | | | |
| Second surface, | 2.0342E−06 | 2.8277E−09 | −1.4945E−08 | 4.8270E−10 |
| main lens | | | | |
| First surface, aux | 2.9057E−05 | −7.3741E−07 | −6.2739E−07 | 4.6747E−08 |
| lens | | | | |
| Second surface, | 5.0881E−04 | −7.0040E−05 | −1.2459E−05 | 2.1608E−06 |
| aux lens | | | | |

(3) Two exciting beams B₁ and B₂ are pre-shaped to arrive at the focusing/collecting arrangement as one collimated and the other slightly diverging/converging (semi-infinite conjugation). This can be achieved by using one collimator for one of the beams, e.g., lens 22B in the optical path of beam B₂, and appropriate relative accommodation of the other light source with respect to the focusing/collecting arrangement. Alternatively, the collimator is used for one of the beams, while for the other beam, e.g., B₁, an additional lens 22A is provided being appropriately designed and accommodated with respect to the light source 12A to provide the desired divergence/convergence of the beam B₁, when the beam arrives at the focusing/collecting arrangement. The parameters of the lenses of the focusing/collecting arrangement are exemplified in Table 2. This table also includes description of the collimating lens in the first optical path, and the “almost collimating” lens in the second path, as well as those of cylindrical lenses 24A and 24B (constituting an additional beam shaping means) in the paths of light beams emerging from the light sources (diodes). These lenses 24A and 24B are designed to correct for astigmatism effects of the light sources 12A and 12B, and affect the beams B₁ and B₂, respectively, to provide substantially circular cross-section thereof. Yet another option is to use collimators 22A and 22B, and an additional lens (not shown) accommodated in the optical path of one of the beams B₁ and B₂ to provide the desired degree of the beams' divergence/convergence. In the case of collimated and slightly diverging/converging exciting beams, the optical system is optimized with the pre/post shaping optics for the focusing and collection, and the results is the specified second “collimation” lens.

TABLE 2

| | | | | Semi- | |
|---|---|---|---|---|---|
| Description | Curvature | Thickness | Glass | Diameter | Conic |
| Diode model | 0.0000E+00 | | | 2.7700E−03 | 0.0000E+00 |
| First LD | 0.0000E+00 | 5.0000E−01 | BK7 | 3.2473E−03 | 0.0000E+00 |
| astigmatic | | | | | |
| correction lens, | | | | | |
| 1st surface | | | | | |
| First LD | 0.0000E+00 | | | 1.1099E−01 | 0.0000E+00 |
| astigmatic | | | | | |
| correction lens, | | | | | |
| 2nd surface | | | | | |
| First LD | 1.1478E−01 | 4.0000E+00 | BK7 | 4.1558E+00 | −3.2260E+00 |
| “collimating” | | | | | |
| lens, 1st surface | | | | | |
| First LD | −5.6104E−02 | | | 4.3303E+00 | −4.9254E+00 |
| “collimating” | | | | | |
| lens, 2nd surface | | | | | |
| Main lens 1st | 7.7291E−02 | 1.8161E+00 | PBH71 | 3.9066E+00 | −2.6716E+00 |
| surface | | | | | |
| Main lens 2nd | −3.9435E−01 | | | 3.9384E+00 | −1.3925E+00 |
| surface | | | | | |
| Auxiliary lens | −1.1396E−01 | 1.7942E+00 | C0550 | 3.0176E+00 | −9.2640E+00 |
| 1st surface | | | | | |
| Auxiliary lens | 3.4459E−01 | | | 2.1210E+00 | −9.2528E−01 |
| 2nd surface | | | | | |
| Second LD | 0.0000E+00 | 5.0000E−01 | BK7 | 2.6651E−03 | 0.0000E+00 |
| astigmatic | | | | | |
| correction lens, | | | | | |
| 1st surface | | | | | |
| Second LD | 0.0000E+00 | | | 9.1761E−02 | 0.0000E+00 |
| astigmatic | | | | | |
| correction lens, | | | | | |
| 2nd surface | | | | | |
| Second LD | 1.1478E−01 | 4.0000E+00 | BK7 | 3.1635E+00 | −2.2673E+04 |
| “collimating” | | | | | |
| lens, 1st surface | | | | | |
| second LD | −5.6104E−02 | | | 3.7080E+00 | −5.7874E−01 |
| “collimating” | | | | | |
| lens, 2nd surface | | | | | |

As indicated above, the system of the present invention operates to simultaneously focus two exciting beams of different wavelengths onto desirably distanced from each other sites in the medium, and to collect the excited light of a third different wavelength coming from the interrogated site to form an excited light beam to be detected. The requirement for the distance between the sites is dictated by the operational mode of the system for tracking the data units in the disk, and the formatting of the disk.

For example, a recording laser is to be kept at a fixed focal distance while a reading laser is wobbled around the previous layer so as to ensure tracking using conical scanning. This method of tracking is disclosed in the following patent publications US 20030174594 and WO 03/077240, both assigned to the assignee of the present application. These techniques are aimed at correcting tracking errors while reading/recording in an optical storage medium formed of multiple tracks arranged in different layers. A light spot that is nominally focused on to a track is directed into the optical storage medium. The spot is continually moved in axial and radial directions. A signal having amplitude which varies according to respective offsets from the track in radial and axial directions is received, and used to determine a direction of a respective offset from the track in radial and axial directions, and adjust a location of the reading spot accordingly. A formatting method used in conjunction with said tracking method is disclosed in co-pending U.S. patent application assigned to the assignee of the present application. According to this technique, a formatter for inscription of marks onto a 3D translucent optical medium is provided to enable recording and retrieval of information from the medium. The formatter includes a clamping mechanism to hold the media, an optical unit calibrated to focus at least one diffraction limited spot within the medium at a respective depth therein, a light source optimized for the inscription of marks, and at least one actuator for moving the at least one spot relative to the medium. A data layer is inscribed onto the disc requiring tracking an adjacent layer, thus, recording is achieved by having a first beam-spot reading a first layer, typically by a two photon process and a second beam-spot recording data in a second layer. The requirement emerging from this setup is that the vertical distance between the beam spots will be exactly the required distance between the layers. Another example (also disclosed in the above-indicated co-pending U.S. patent application assigned to the assignee of the present application) utilizes a servomechanism to indicate the location of the read spot relative to tracks formatted in the medium. In this setup, the direction and distance between the read spot and the recording spot need to be known exactly and tailored to the disc format. The simplest approach would be to have this distance nullified.

FIGS. 2A-2C exemplify the operation of the system 10. Three different steps in the data reading/recording procedure are shown, corresponding to reading/recording of different sites (at different depths) in the medium, respectively. It should be understood that the beam propagation is shown here schematically, and may relate to either one of the above-described cases differing from each other by the exciting beams' arrival at the focusing/collecting arrangement—the plane of the main lens 14A, namely (1) two exciting beams arriving at the focusing/collecting arrangement are collimated and slightly non-collimated, respectively (infinite and semi-infinite conjugation); (2) both exciting beams arriving at the focusing/collecting arrangement are slightly non-collimated (semi-infinite conjugation); (3) both exciting beams arriving at the focusing/collecting arrangement are collimated (infinite conjugation); and (4) both exciting beams arriving at the focusing/collecting arrangement are non-collimated to a larger degree (finite conjugation).

In this specific example of FIGS. 2A-2C, which is more relevant to the above cases (1)-(3), than case (4), the main lens 14A is mounted for movement with respect to the corrector 14B and to the pre/post shaping means 15 (which may and may not be constituted by a lens assembly, as described above), while the corrector 14B and the pre/post shaping means 15 are stationary mounted with the corrector being kept at a certain fixed distance from the disk 16. The focal plane P of the entire focusing/collecting arrangement moves inside the disk 16 towards its surface as the main lens 14A moves away from the corrector 14B. It should be noted, although not specifically shown, that for the case (4) (finite conjugation of each of the exciting beams), both lens assemblies 14A and 14B are preferably moved along the optical axis with respect to the light source and detector assemblies and with respect to the medium. As for case (3), the main lens assembly is preferably a so-called “doublet”.

The doublet-based focusing/collecting arrangement of the present invention is exemplified in FIGS. 3A-3B. Here, the focusing/collecting arrangement includes a main lens assembly 114A and a corrector lens 114B, wherein the main lens assembly is a “doublet” being formed of two portions of different materials and geometries, both being aspheric, and the entire focusing/collecting arrangement serves for correcting both chromatic and spherical aberrations. The different lens' portions L₁ and L₂ are designed so as to process (focus) the beams B₁ and B₂, respectively, and to collect excited light to form beam B₃. In the example of FIG. 3A, the two different portions L₁ and L₂ of the main lens assembly 114A are in the form of two spaced-apart lenses. In the example of FIG. 3B, these portions L₁ and L₂ are two lenses attached to each other. The following Table 3 exemplifies the parameters of the doublet-based focusing/collecting arrangement in the example of FIG. 3B:

TABLE 3

| Comment | Curvature | Thickness | Glass | Semi-Diameter | Conic |
|---|---|---|---|---|---|
| Doublet first | 2.7043E−01 | 2.3679E−01 | PBH71 | 3.2500E+00 | −1.0431E+00 |
| surface | | | | | |
| Doublet | 5.3505E−02 | 3.5875E+00 | C0550 | 3.0581E+00 | 3.3296E+01 |
| second surface | | | | | |
| Doublet third | 6.4068E−01 | | | 3.0014E+00 | −7.7739E+00 |
| surface | | | | | |
| Auxiliary lens | 2.4287E−01 | 3.3156E+00 | PBH71 | 2.7030E+00 | −5.3456E−01 |
| first surface | | | | | |
| Auxiliary lens | 3.1991E−01 | | | 1.4370E+00 | −9.3719E−01 |
| second surface | | | | | |

Aspheric, higher order coefficients:

| Comment | 2nd order | 4th order | 6th order | 8th order |
|---|---|---|---|---|
| Doublet first | 1.0401E−01 | −2.7209E−03 | 5.3114E−05 | 4.8599E−05 |
| surface | | | | |
| Doublet | 2.9812E−01 | −2.9169E−03 | 4.0955E−04 | 2.6000E−05 |
| second surface | | | | |
| Doublet third | 4.3648E−02 | −1.2087E−02 | −1.2758E−04 | 2.8437E−05 |
| surface | | | | |
| Auxiliary lens | −8.6208E−02 | −6.2827E−04 | 8.6621E−05 | −3.6727E−05 |
| first surface | | | | |
| Auxiliary lens | −1.1991E−01 | −4.2867E−04 | 5.2429E−03 | −7.7184E−03 |
| second surface | | | | |
| Comment | 10th order | 12th order | 14th order | 16th order |
| Doublet first | −6.5926E−06 | −1.7765E−07 | 5.3165E−08 | −2.6789E−09 |
| surface | | | | |
| Doublet | 5.4191E−06 | −1.5094E−06 | −3.6657E−07 | 3.7156E−08 |
| second surface | | | | |
| Doublet third | −1.1353E−06 | −1.3887E−07 | 3.0890E−08 | −1.7986E−09 |
| surface | | | | |
| Auxiliary lens | 8.4868E−06 | −1.1913E−06 | 9.3002E−08 | −3.0991E−09 |
| first surface | | | | |
| Auxiliary lens | 6.5593E−03 | −3.2709E−03 | 8.9057E−04 | −1.0237E−04 |
| second surface | | | | |

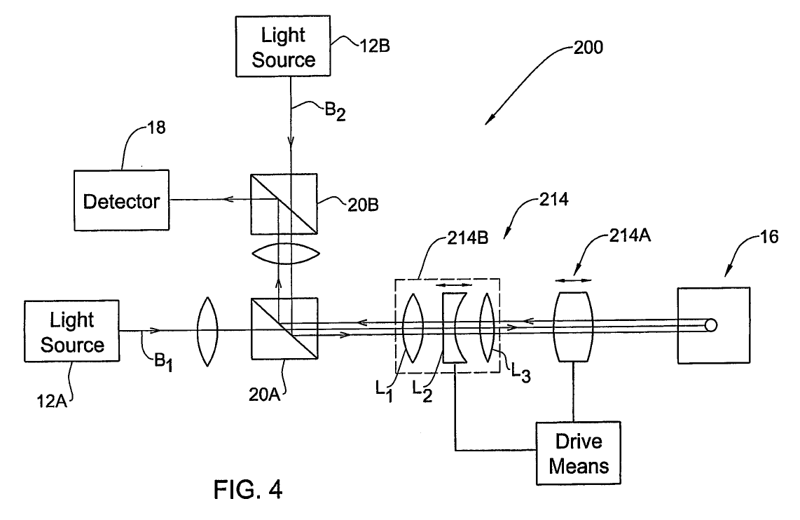

Referring to FIG. 4, there is schematically illustrated an optical system 200, according to yet another embodiment of the invention, for reading/recording data in a disk 16. To facilitate understanding, the same reference numbers are used to identify those components that are common in the examples of FIGS. 1 and 4. The system 200 comprises a light source assembly 12, which in the present example includes two light sources 12A and 12B; a detector assembly 18; wavelength-selective beam splitters 20A and 20B; a lens assembly including lenses 22A and 22B (constituting pre-shaping and post-shaping means), and preferably also lenses 24A and 24B for affecting the cross-section of the emitted exciting beams B₁ and B₂; a focusing/collecting arrangement 214; and a drive means 26.

In the present example, the focusing/collecting arrangement comprises an objective lens arrangement 214A and an aberration correction assembly 214B that are arranged in a spaced-apart relationship within the optical path OA of the focusing/collecting arrangement, wherein the objective lens assembly 214A is located closer to the disk 16 and the aberration correction assembly 214B is a multiple-lens assembly. In the present example, the corrector 214B includes three optical elements (lenses) L₁, L₂ and L₃. The correction of spherical aberration is attained by varying the position of the corrector relative to the objective lens arrangement and relative to the disk, as the depth of focus within the disk material is altered. This requires relative displacement of at least an intermediate lens L₂ of the corrector along the optical path OA, and possibly also a relative displacement between the objective lens 214A and the disk. In the present example, the drive means 26 is associated with both the corrector lens L₂ and the objective lens. The drive means 26 may be of the kind providing a mechanical displacement of the corrector lens L₂ or a motor driving the corrector for movement along the optical axis OA in conjunction with the movement of the focusing lens assembly 214A, in accordance with the predicted behavior of the spherical aberration for a given depth of focus.

In all the examples of the invention, the movement of the optical element(s) may be controlled by using a feedback mechanism from the photodetector 18 sensitive to the tightness of the focus of reading/recording beams, or may be controlled using a feedback from a mechanical device, and optionally using depth information that was inscribed onto the disk in a previous stage.

The optical system of the present invention is designed to operate with a broad range of depths, e.g., 0-3 mm, with high numerical aperture, e.g., NA>0.5, taking into account the nature of the storage material, the range of motion necessary, and the wavelengths of light in use, while continuing the compensation for the spherical aberration over the whole range of motion. Either one of semi-infinite, infinite and finite conjugate implementations can be used.

Those skilled in the art will readily appreciate that modifications and changes can be applied to the embodiments of the invention as hereinbefore exemplified without departing from its scope defined in and by the appended claims.

1. A method for use in recording/reading data from an array of data units within a three-dimensional storage medium, the method comprising:
(a) providing exciting radiation in the form of first and second light beams of first and second different wavelengths, respectively;
(b) concurrently directing said first and second light beams and focusing them onto two sites in the medium at a predetermined distance between them, and collecting excited light of a third wavelength coming from the excited site in the medium to form a third excited light beam and direct it towards a detector assembly, while correcting for chromatic and spherical aberrations of the light focusing and collection, said focusing comprising passing the exciting light beams through a focusing/collecting arrangement comprising two lens assemblies arranged in a spaced-apart relationship along an optical axis of the focusing/collecting arrangement, one of said two lens assemblies being configured to perform the majority of light bending required for the focusing of the exciting light, and the other of said two lens assemblies being configured to carry out the majority of compensation for changing spherical aberration introduced by a change in a thickness of the medium into which the exciting light is being focused;
(c) sequentially repeating step (b) for successive sites in the medium with varying depth of focus.

2. The method of claim 1, wherein said collecting includes passing the excited light through the same focusing/collecting arrangement.

3. The method of claim 1, wherein the focusing/collecting arrangement is configured and oriented relative to the medium and to light source and detector assemblies for focusing the exciting light beams to sites spaced from each other a predetermined distance and collecting the excited light from the excited site in the medium.

4. The method of claim 2, wherein said two lens assemblies are accommodated in the optical path of the exciting and excited light beams, said one of said two lens assemblies being designed to perform the majority of light bending required for the focusing of the exciting light and for collecting the excited light.

5. The method of claim 1, wherein said lenses of the focusing/collecting arrangement have different surface geometries, at least one of these surfaces being aspheric.

6. The method of claim 1, wherein that one of the two lens assemblies which is designed to compensate for changing spherical aberration is located closer to the medium.

7. The method of claim 1, wherein each of said two lens assemblies comprises a single lens.

8. The method of claim 1, wherein that one of the two lens assemblies which is designed to perform the majority of light bending is configured to define two lens portions of different materials and geometries.

9. The method of claim 8, wherein said lens portions are separate lens elements arranged in a spaced-apart relationship along the optical axis and are arranged either with a gap between them or being attached to each other.

10. (canceled)

11. The method claim 1, wherein said lens assembly located closer to the medium includes a flying lens.

12. The method of claim 1, wherein that one of the two lens assemblies which is designed to perform the majority of light bending is located closer to the medium, the other one of the two lens assemblies being a multiple-lens assembly.

13. The method of claim 1, wherein the varying of the depth of focus comprises displacing at least one of the lenses of the focusing/collecting arrangement with respect to at least one other lens thereof along an optical axis defined by the focusing/collecting arrangement.

14. The method of claim 13, comprising displacing the focusing/collecting arrangement with respect to the medium.

15. The method of claim 1, wherein the varying of the depth of focus comprises varying the optical path lengths of the exciting light beams and the optical path of the excited light while propagating towards and away from the medium. respectively.

16. The method of claim 15, comprising displacing light sources, detector and focusing/collecting arrangement with respect to the medium.

17. The method of claim 15, comprising displacing the medium with respect to the focusing/collecting arrangement.

18. The method of claim 1, comprising pre-shaping the exciting beams so as to provide arrival of each of the excited beams to the focusing/collecting arrangement with a desired degree of the beam divergence/convergence, and post-shaping of the excited beam so as to provide the excited beam arrival at a detector assembly with a desired degree of the excited beam divergence/convergence.

19. The method of claim 18, wherein said pre-shaping comprises carrying out either a small or a large degree of divergence/convergence of each of the first and second exciting light beams arriving at the focusing/collecting arrangement, thereby providing, respectively, either semi-infinite or finite conjugation of the first and second beams.

20. (canceled)

21. The method of claim 19, comprising passing each of the first and second exciting light beams through a lens assembly appropriately designed and oriented with respect to a corresponding light source to provide the desired degree of the beam divergence/convergence.

22. The method of claim 19, comprising accommodating the focusing/collecting arrangement at certain distances from first and second light sources generating said first and second light beams, to provide the desired degree of divergence/convergence of each of the first and second light beams when arriving at the focusing/collecting arrangement.

23. The method of claim 18, wherein said pre-shaping comprises carrying out one of the following: collimating one of the first and second exciting light beams and providing a small degree of divergence/convergence of the other of said first and second exciting beams when arriving at the focusing/collecting arrangement so as to provide semi-infinite conjugation of said other beam; or collimating each of said first and second exciting light beams, while propagating towards the focusing/collecting arrangement.

24. (canceled)

25. The method of claim 1, wherein that one of the two lens assemblies of the focusing/collecting arrangement that is located closer to the medium is kept at a constant distance from the medium, and at least one other lens of the focusing/collecting arrangement is movable along the optical axis.

26. The method of claim 12, wherein said multiple-lens assembly comprises three lenses arranged in a spaced-apart relation along the optical axis.

27. The method of claim 26, wherein said varying of the depth of focus comprises moving an intermediate one of said three lenses along the optical axis.

28. The method of claim 1, wherein said first and second exciting beams are operated to carry out one of the following: the first and second beams are respectively reading and recording light beams; the first and second exciting beams are reading light beams; and first and second exciting beams are recording light beams.

29. (canceled)

30. (canceled)

31. An optical system for use in recording/reading data from an array of data units within a three-dimensional storage medium, the system being configured for correcting for aberrations of light focusing and collection, and comprising:
(a) a light source assembly operable to produce exciting radiation in the form of first and second light beams of first and second different wavelengths, respectively, thereby enabling excitation of sites in the medium to produce excited light of a third wavelength;
(b) a detector assembly for receiving the excited light and generating data indicative thereof;
(c) a focusing/collecting assembly configured to enable directing the exciting light beams and focusing them onto the sites spaced from each other a predetermined distance and for collecting the excited light to form an excited light beam to propagate towards the detector assembly, said focusing/collecting arrangement comprising two lens assemblies arranged in a spaced-apart relationship along an optical axis of the focusing/collecting arrangement, one of said two lens assemblies being configured to perform the majority of light bending required for the focusing of the exciting light and collecting the excited light, and the other of said two lens assemblies being configured to carry out the majority of compensation for changing spherical aberrations introduced by a change in a thickness of the medium into which the exciting light is being focused; and
(d) a drive means associated at least with the focusing/collecting arrangement to move at least one of lenses of the focusing/collecting arrangement along the optical axis of the focusing/collecting arrangement to thereby effect variation of a depth of focus, while the exciting radiation is applied to successive sites in the medium during a relative displacement between the system and the medium.

32. The system of claim 31, comprising a beam shaping assembly accommodated in the optical paths of the first and second exciting beams and operating to pre-shape each of these beams to arrive at the focusing/collecting arrangement with desired degree of divergence/convergence, and to post-shape the collected excited light beam while propagating towards the detector.

33. The system of claim 31 or 32, wherein the lenses of the focusing/collecting arrangement have different surface geometries, at least one of these surfaces being aspheric.

34. The system of claim 31, wherein that one of the two lens assemblies which is designed to compensate for changing spherical aberration is located closer to the medium.

35. The system of claim 34, wherein each of said two lens assemblies comprises a single lens.

36. The system of claim 34, wherein that one of the two lens assemblies which is designed to perform the majority of light bending is configured to define two lens portions of different materials and geometries.

37. The system of claim 36, wherein said lens portions are separate lens elements arranged in a spaced-apart relationship along the optical axis either with a gap between them or being attached to each other.

38. (canceled)

39. The system of claim 34, wherein said lens located closer to the medium is a flying lens.

40. The system of claim 31, wherein that one of the two lens assemblies which is designed to perform the majority of light bending is located closer to the medium, the other one of the two lens assemblies being a multiple-lens assembly.

41. The system of claim 37, wherein said multiple-lens assembly comprises three lenses arranged in a spaced-apart relation along the optical axis

42. The system of claim 31, wherein said drive means is configured and operable carry out at least one of the following: to displace that one of the two lens assemblies, which is designed to compensate for changing spherical aberration, along the optical axis; or to move each of the two lens assemblies of the focusing/collecting arrangement along the optical axis.

43. (canceled)

44. The system of claim 32, wherein said beam shaping assembly has one of the following configurations: (i) comprises a lens assembly designed to provide a small degree of divergence/convergence of each of the first and second exciting light beams when arriving at the focusing/collecting arrangement to provide semi-infinite conjugation of each of said beams; (ii) comprises a lens assembly designed to provide collimation of one of the first and second light beams and a small degree of divergence/convergence of the other of said first and second exciting beams when arriving at the focusing/collecting arrangement to thereby provide a semi-infinite conjugation of said other beam; (iii) comprises collimating lenses in the optical paths of the first and second light beams, respectively, propagating towards the focusing/collecting arrangement; and (iv) comprises a lens assembly designed to provide a large degree of divergence/convergence of each of the first and second exciting light beams when arriving at the focusing/collecting arrangement to thereby provide finite conjugation of each of the first and second light beams.

45-47. (canceled)

48. The system of claim 31, comprising a lens assembly in the optical path of the first and second exciting beams generated by the light sources to affect the beams to provide substantially circular cross-section thereof.
